(19) United States
(12) Patent Application Publication
(10) Pub. No.: US 2015/0342171 A1
(43) Pub. Date: Dec. 3, 2015

(54) Trash Can Trap

(71) Applicant: Steffen Seyss, Everett, WA (US)

(72) Inventor: Steffen Seyss, Everett, WA (US)

(21) Appl. No.: 14/727,716

(22) Filed: Jun. 1, 2015

Related U.S. Application Data
(60) Provisional application No. 62/005,953, filed on May 30, 2014.

(51) Int. Cl. A01M 25/00; A01M 23/24; A01M 23/00

(52) U.S. Cl. CPC A01M 25/004; A01M 23/00; A01M 23/24

(57) ABSTRACT

A trash can trap used to trap and kill rats, mice, and other rodents. The trash can trap includes a trap container and a trap lid. The trap lid is connected to a rim of the trap container. The trap container and the trap lid are used to prevent rodents from escaping after entering the trap container. The trap lid may be opened to dispose of dead rodents. The apparatus includes an at least one trap entrance which allows rodents to enter the trap container. A bait item is used to entice rodents into the trap container. Each of the at least one trap entrances includes an entrance tube which extends through the trap lateral portion of the trap container. The apparatus includes a trash can which houses the trap container and the trap lid. The trap entrance extends from the trap container to the outside of the trash can.

The current application claims a priority to the U.S. Provisional Patent application Ser. No. 62/005,953 filed on May 30, 2014. The current application is filed on Jun. 1, 2015 while May 30, 2015 was on a weekend.

### FIELD OF THE INVENTION

The present invention relates generally to a device for trapping pests such as rats, mice, and other rodents. More specifically, the present invention is a trash can trap that may be attached to the inside of a trash can for baiting and capturing rats and other pests. The trash can trap facilitates removal of captured rats from the trash can as well.

### BACKGROUND OF THE INVENTION

A commonly encountered problem in both outdoor and indoor environments is the presence of pests. Rats in particular are well-known pests that commonly infest homes behind walls, around pipes, and near trash cans, which serve as food sources. In addition to their unsightly nature, rats are often dirty and highly elusive in avoiding capture and extermination. This is partially due to the fact that rats become more active at night. Rats are intelligent and capable of learning as well. As such, rats are often able to gain access to garbage and other waste that has been discarded by humans. Garbage is most commonly disposed of in plastic garbage bags that are often tied and placed into dedicated garbage receptacles. Rats are able to chew through the garbage bag material in order to gain access to the garbage within. Rat management involves ensuring that rats are unable to enter indoor environments altogether by sealing cracks and other points of access that are frequently used by rats. Traps may also be set up in order to capture and/or kill rats as well. Another frequently utilized means of rat management is rat poison combined with bait. While poison is effective in attracting and killing rats, the poison is considered harmful to the environment as well as to people in the environment in which the rat poison is used. Additionally, because many poisons do not kill immediately, rats are prone to dying sometime after ingesting poison in an area that is not easily accessible by humans. The present invention seeks to address the aforementioned issues relating to rat management as well as provide users with a practical, convenient, and straightforward solution.

The present invention is a trash can trap that is primarily intended for the capture of rats and similar pests. In the preferred embodiment of the present invention, a trap container may be retrofit to a trash can, secured in place, and baited in order to attract rats. The trap container may be installed within the base of the trash can utilizing fasteners such as screws and comprises an open upper end. The open upper end may be covered and uncovered via a loosely hinged and weighted lid. Connected to the trap container is at least one trap entrance that allows a rat to enter the interior of the trap container from the exterior of the trash can or similar receptacle. Material may be removed from the side wall of the trash can in order to accommodate the trap entrance (for example, by drilling). The trap entrance comprises a one-way door. The one-way door allows a rat to enter the interior of the trap container from the exterior of the trash can, but prevents the rat from exiting through the same door, trapping the rat within the interior of the trap container. The loosely hinged and weighted lid covering the upper end of the trap container prevents the rat from escaping through the upper end of the trap container. Inside the trap container, a number of types of traps may be used to kill a trapped rodent. One embodiment includes a mechanical trap that can be set and reset via a trap-reset pedal. Other trap types include poison and electrocution traps. When the trash can on which the trap is installed is turned upside down and emptied, the weight of the loosely hinged and weighted lid facilitates the opening and uncovering of the interior of the trap container. This allows the dead or dying rat within the trap container to exit the interior of the trap container and be discarded along with the garbage within the trash can. The trash can trap may then be re-baited if necessary to prepare for trapping additional rats.

The trap container of the present invention is not limited with respect to the specific design of the trash can trap. As such the trap container is available in various embodiments in order to facilitate usage with various types and styles of trash cans. In various alternative embodiments of the present invention, the trap container is not retrofit to an existing trash can but rather the trap container may be directly integrated with the base of a trash can.

### BRIEF DESCRIPTION OF THE DRAWINGS

FIG. 1 is a perspective view of the present invention with the trap lid in a closed position.

FIG. 2 is a perspective view of the present invention with the trap lid in an open position.

FIG. 3 is a top view of the present invention.

FIG. 4 is a front section view of the present invention taken about the line A-A in FIG. 3, wherein the trap reset pedal is mechanically coupled to the mechanical trap.

FIG. 5 is a perspective section view of the present invention taken about the line A-A in FIG. 3.

FIG. 6 is a perspective view of a second embodiment of the present invention, wherein a poisonous bait item is used.

FIG. 7 is a top view of the second embodiment of the present invention.

FIG. 8 is a front section view of the second embodiment of the present invention taken about the line B-B in FIG. 7.

FIG. 9 is a perspective view of the present invention showing the trash can.

FIG. 10 is a top view of the present invention showing the trash can.

FIG. 11 is a perspective section view taken about the line C-C in FIG. 10 showing the trap container inside of the trash can.

### DETAILED DESCRIPTION OF THE INVENTION

All illustrations of the drawings are for the purpose of describing selected versions of the present invention and are not intended to limit the scope of the present invention.

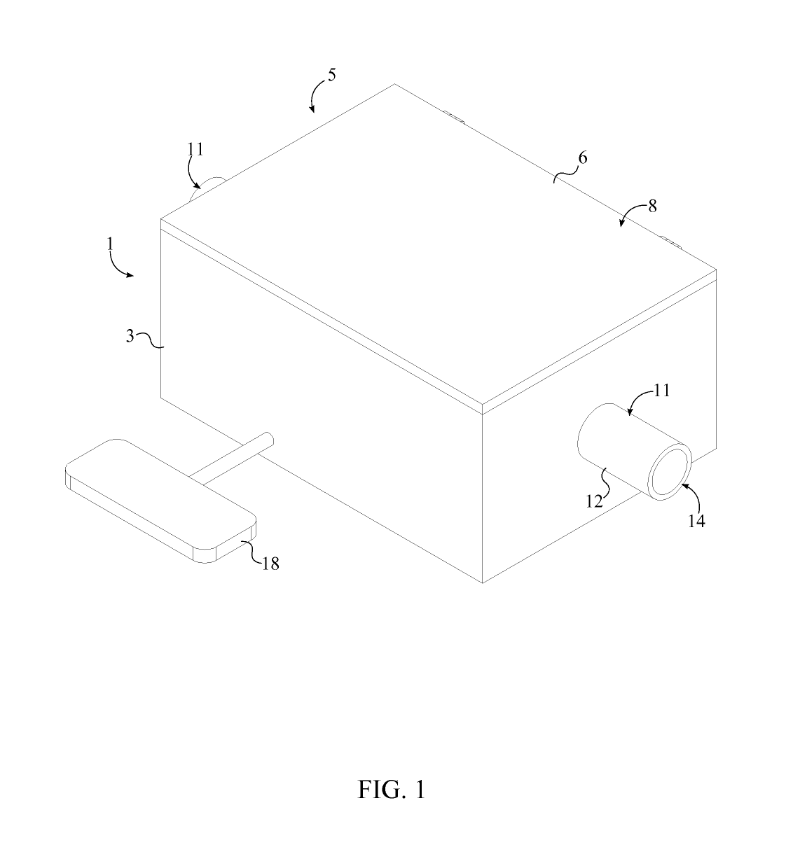

With reference to FIGS. 1-4, the present invention is a trash can trap that is used to capture and kill rodents that may be attracted to the contents of a trash can. The present invention comprises a trap container 1, a trap lid 5, and at least one trap entrance 11, and a bait item 16. The trap container 1 makes up the majority of the present invention and is used to house the bait item 16. The trap container 1 is also used to trap rodents. Inside the trap container 1, a mechanical, poison, or electrocution trap may be used to kill rodents. Like traditional mouse traps, a mechanical trap may be used to swiftly strike and kill rodents. A poison trap or simply a bait item 16 made from a poisonous material may be placed inside the trap container and used to sicken and kill rodents. An example of an electrocution trap could utilize solar panels placed on a trash can to provide an electrical current strong enough to kill any rodents that step on an electrocution plate. All of these trap types may be used with the present invention.

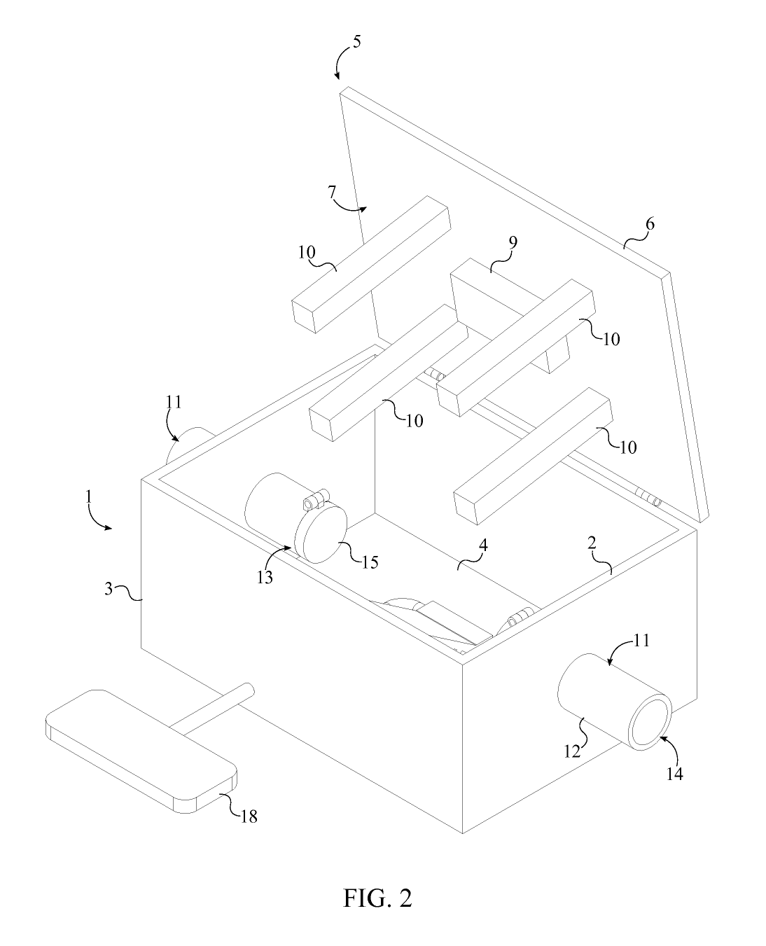

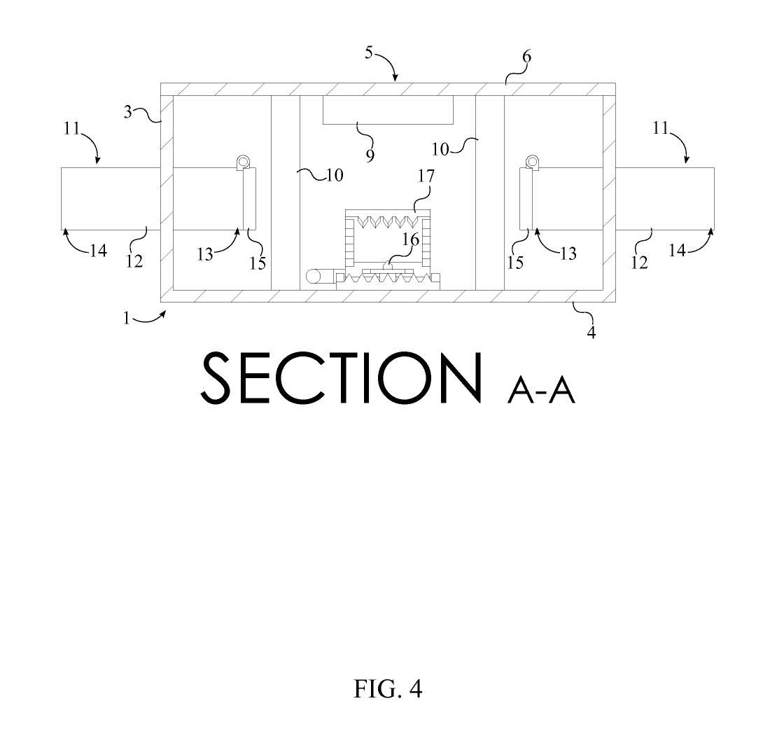

In reference to FIG. 2-4, the trap container 1 comprises a rim 2, a trap lateral portion 3 and a trap base 4. The rim 2 and the trap base 4 are positioned opposite each other about the trap lateral portion 3; the rim 2 is perimetrically connected along the trap lateral portion 3. The trap base 4 is perimetrically and perpendicularly connected to the trap lateral portion 3. This configuration creates a container that is open along the rim 2. The trap lid 5 is hingedly connected to the rim 2 and is used to prevent rodents from freely entering and exiting the trap container 1. If a rodent is trapped and killed inside the trap container 1, the trap lid 5 may be opened to dispose of the dead rodent. The present invention is designed such that as the trash can is tipped to dispose of trash, the trap lid 5 opens such that dead rodents may also be disposed of. The at least one trap entrance 11 traverses through the trap lateral portion 3. The at least one trap entrance 11 allows rodents to enter the trap container 1 while preventing said rodents from exiting the trap container 1. Each of the at least one trap entrances 11 comprises an entrance tube 12. The entrance tube 12 is positioned normal to the trap lateral portion 3. The entrance tube 12 traverses through the trap lateral portion 3, providing a path into the trap container 1. The bait item 16 is enclosed by the trap container 1 and is used to entice rodents into the trap container 1. The bait item 16, shown in FIG. 4, may either be poisonous or non-poisonous, depending on the embodiment of the present invention.

In reference to FIGS. 1-2, the trap lid 5 comprises a lid panel 6, a weight 9, and a plurality of legs 10. The lid panel 6 is used to cover the rim 2 of the trap container 1 and comprises a proximal surface 7 and a distal surface 8. The proximal surface 7 and the distal surface 8 are positioned opposite each other about the lid panel 6. The proximal surface 7 is positioned adjacent to the rim 2. The weight 9 is adjacently connected to the proximal surface 7. The weight 9 is used to prevent rodents from escaping the trap container 1 when the trap container 1 is in an upright position. The weight 9 makes the trap lid 5 too heavy for rodents to lift and escape from. If the trap container 1 is tilted, as would be done when disposing of trash and rodents, the trap lid 5 is able to swing open such that dead rodents may be discarded. The plurality of legs 10 is adjacently connected to the proximal surface 7. The plurality of legs 10 acts as a structural support for the trap lid 5. While in a trash can, the weight of trash pushes down on the trap lid 5. The plurality of legs 10 acts as a support structure to prevent the lid or the trap container 1 from deforming.

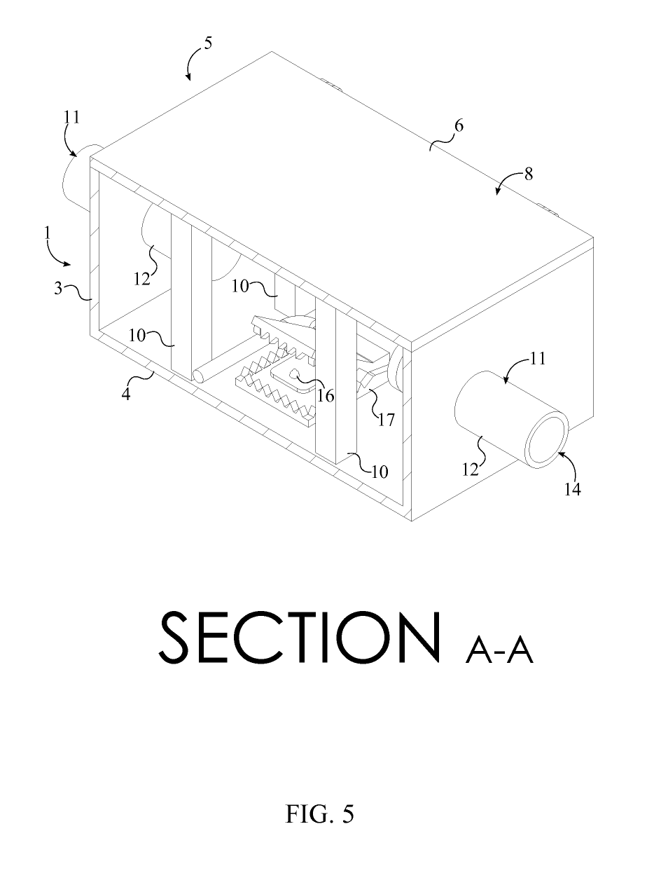

In reference to FIGS. 4-5, each of the at least one trap entrances 11 further comprises a one-way door 15. The one-way door 15 allows rodents to enter the trap container 1 but prevents said rodents from escaping. The entrance tube 12 comprises a proximal end 13 and a distal end 14. The proximal end 13 and the distal end 14 are positioned opposite to each other along the entrance tube 12. The one-way door 15 is hingedly connected to the proximal end 13. The one-way door 15 may be spring loaded or may comprise a self-locking mechanism to prevent rodents from exiting the trap container 1. Under normal conditions, the one-way door 15 presses firmly against the proximal end 13 of the entrance tube 12. As a rodent pushes against the one-way door 15, the one-way door 15 opens such that the rodent is permitted to enter the trap container 1. After the rodent has fully entered the trap container 1, the one-way door 15, returns to a closed position, prohibiting the rodent from exiting the trap compartment 1. The proximal end 13 of the entrance tube 12 is positioned within the trap lateral portion 3. This configuration ensures that if a rodent enters the trap container 1, the rodent will not be able to escape the trap container 1 before dying. As a result, the process of disposing of dead rodents is simplified and does not require that the user touch dead rodents.

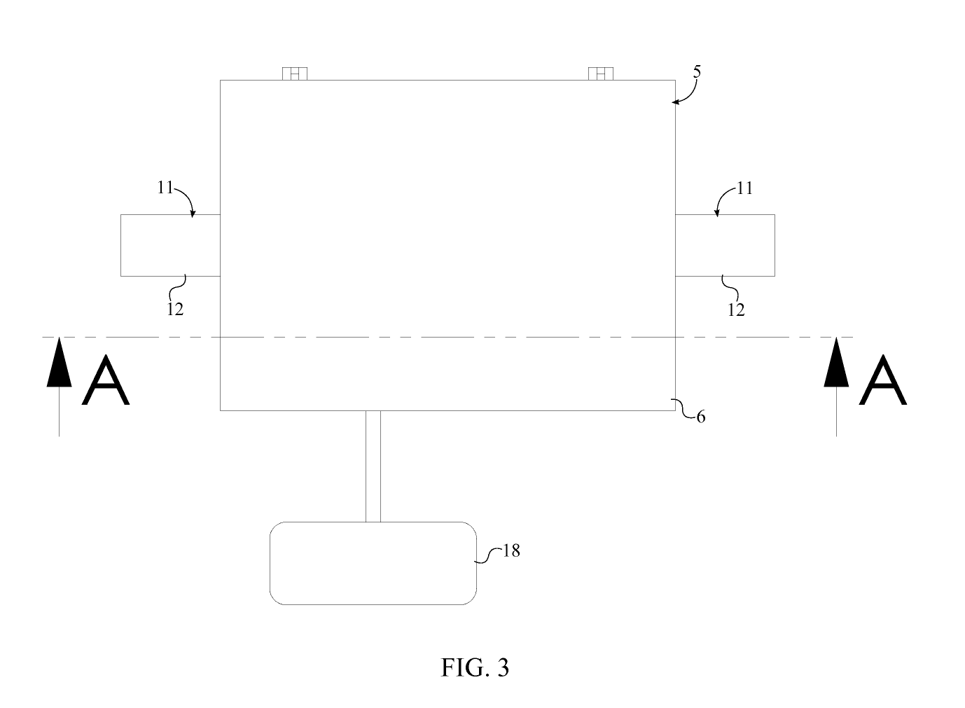

In one embodiment, the present invention further comprises a mechanical trap 17. In reference to FIGS. 3-5, the mechanical trap 17 is used as a means of killing rodents captured within the trap container 1. Like most mouse traps, the mechanical trap 17 may rely on a loaded spring to swiftly strike and kill rodents. Other types of mechanical traps may alternatively be used. The mechanical trap 17 is adjacently connected to the trap base 4 and is positioned within the trap lateral portion 3. The bait item 16 is mounted to the mechanical trap 17. This configuration uses the bait item 16 to entice a rodent into the trap container 1 and to the mechanical trap 17. When the rodent touches the mechanical trap 17, the mechanical trap 17 activates, quickly striking or clamping the rodent.

After the mechanical trap 17 is activated, the mechanical trap 17 must be reset before future use. In reference to FIGS. 3-5, the present invention further comprises a trap-reset pedal 18 which may be used to reset the mechanical trap 17 without touching the mechanical trap 17 itself. The trap-reset pedal 18 is adjacently connected to the trap lateral portion 3 opposite the mechanical trap 17, such that the trap-reset pedal 18 is accessible outside of the trap container 1. The trap-reset pedal 18 is mechanically coupled to the mechanical trap 17 in order to control/open the mechanical trap 17. When the trap container 1 is positioned inside a trash can, the trap-reset pedal 18 extends outwards, from the trash can such that the user may easily reset the mechanical trap 17 without reaching into the trash can. When disposing rodents, the trap-reset pedal 18 may need to be activated to free dead rodents from the mechanical trap 17.

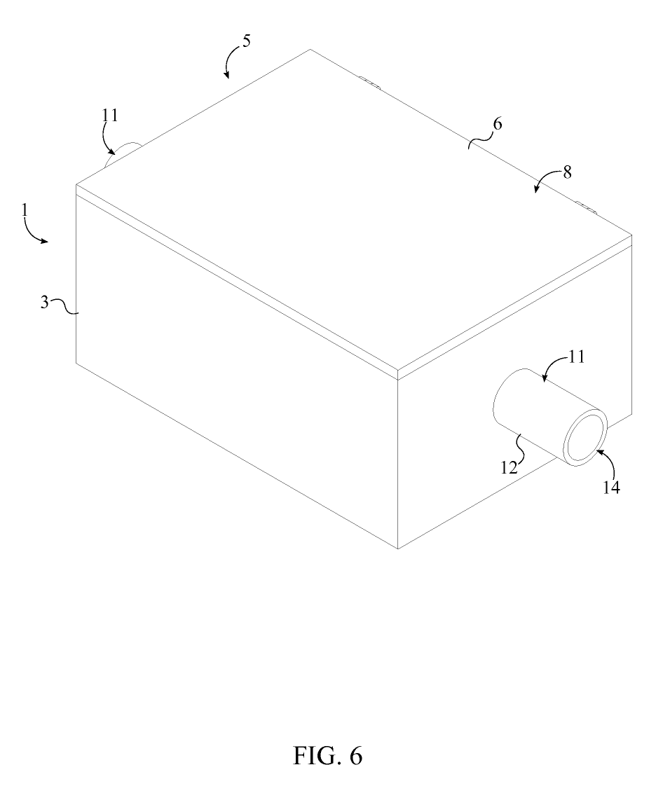

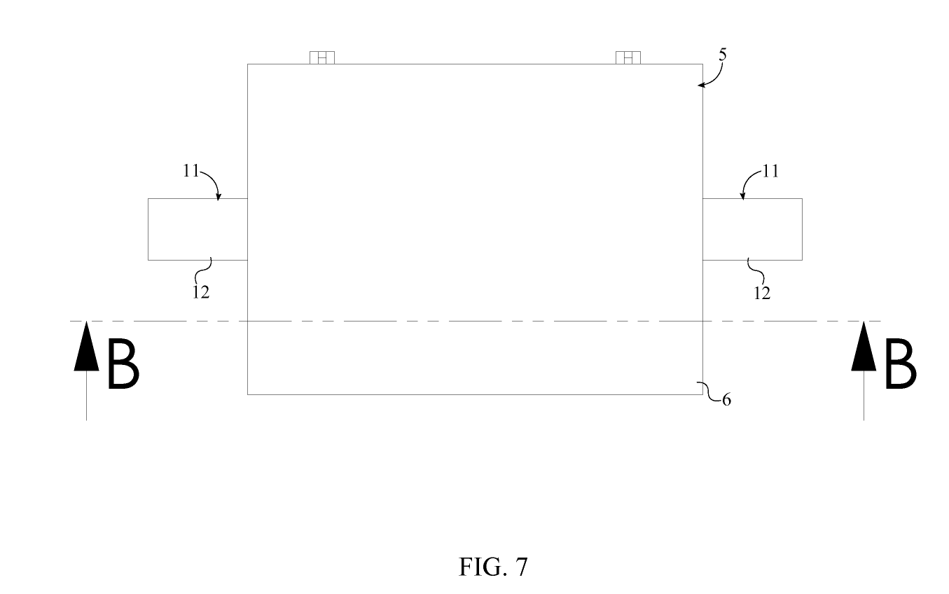

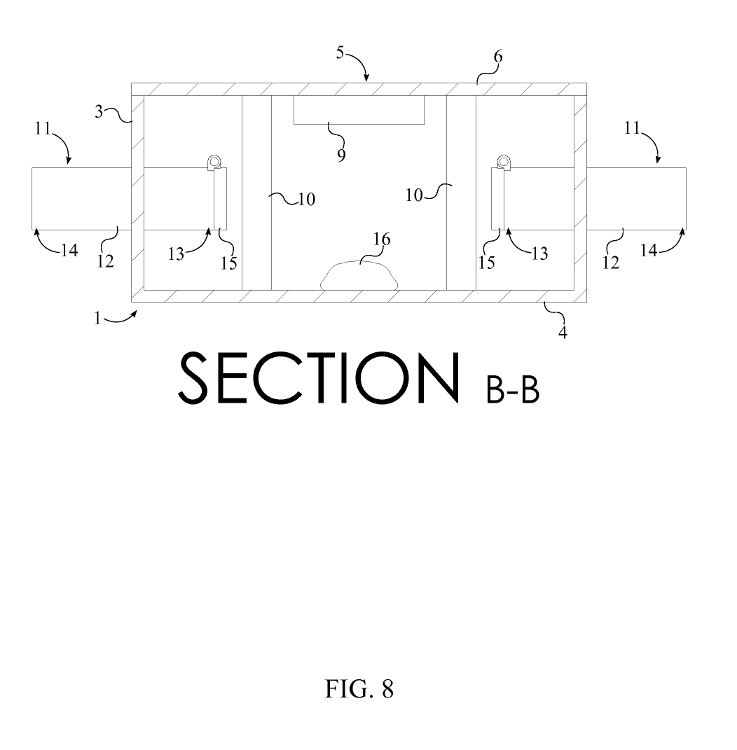

In another embodiment of the present invention, the mechanical trap 17 is not needed. Instead, the bait item 16 inside of the trap container 1 is poisonous. In reference to FIGS. 6-8, if a rodent enters the trap container 1 and eats all or some of the bait item 16, the rodent will begin to die and will be unable to escape the trap container 1. When the user empties out their trash, the dead or dying rodent will be discarded with the trash. Alternatively, in a third embodiment of the present invention, the trap container 1 is made from a poisonous material. Rodents will be attracted to the inside of the trap container 1 by the bait item 16, but will be unable to easily escape. If the rodent attempts to chew through the trap container 1, the material of the trap container 1 will sicken and kill the rodent. As with previous embodiments, the dead or dying rodent may then be disposed of with the trash.

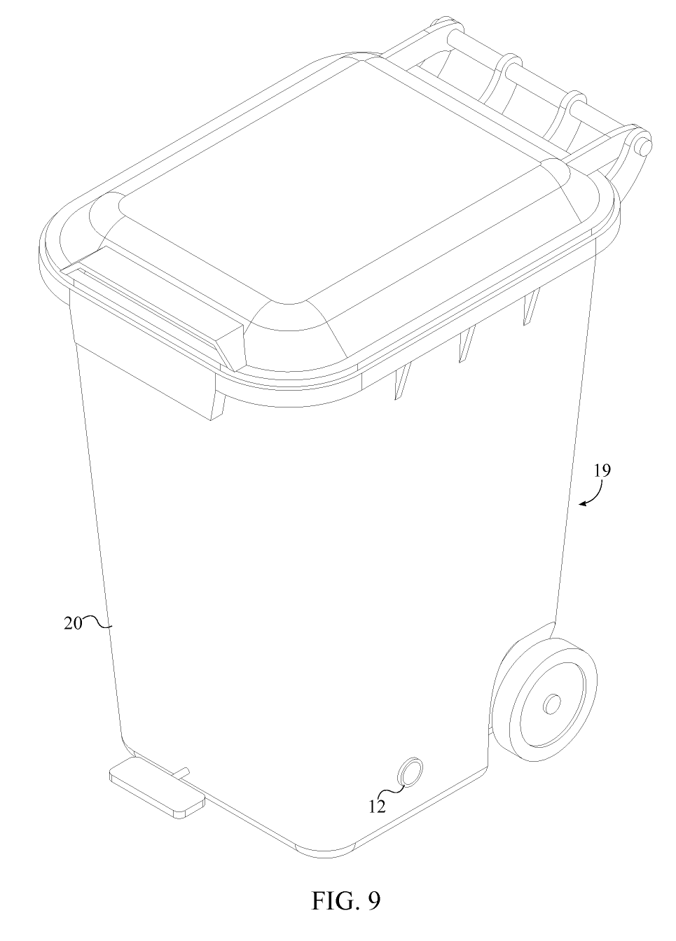

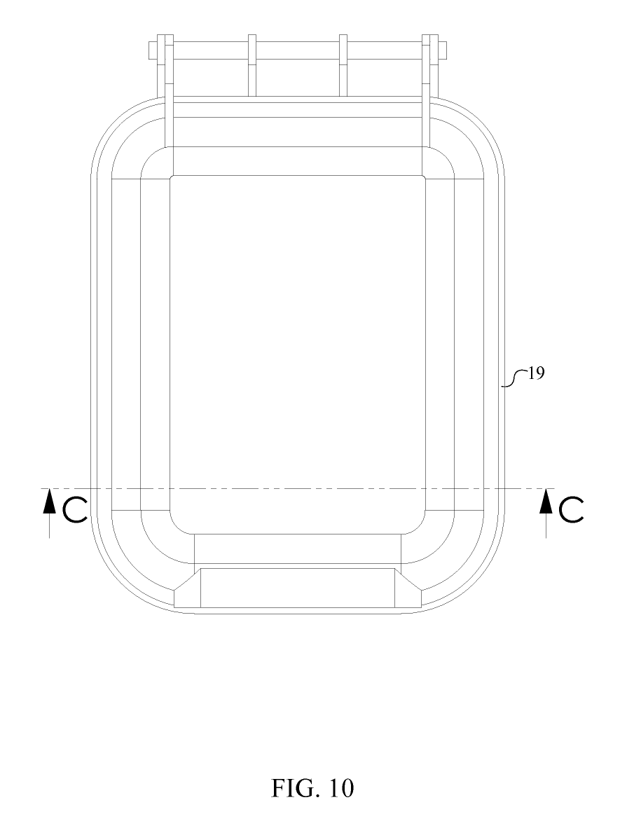

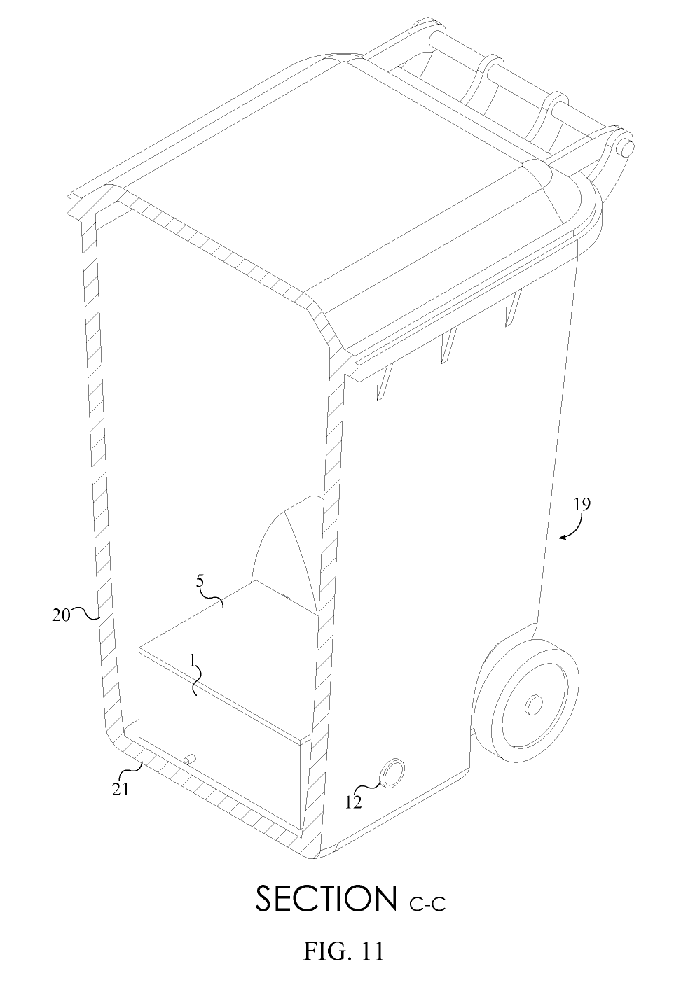

In reference to FIGS. 9-11, the present invention further comprises a trash can 19. The present invention is designed to capture and kill rodents before said rodents are able to dig or chew into garbage contained within the trash can 19. The trash can 19 comprises a can lateral portion 20 and a can base 21. The can lateral portion 20 is perimetrically and perpendicularly connected to the can base 21 in order to form a receptacle for receiving trash. The trap container 1 is positioned into the trash can, wherein the trap lateral portion 3 is positioned within the can lateral portion 20. The entrance tube 12 traverses through the can lateral portion 20. Because the entrance tube 12 leads directly to the trap container 1, there is no way for a rodent to gain access to any trash contained within the trash can 19. The trap base 4 is positioned adjacent to the can base 21, such that the trap lid 5 is accessible through the top of the trash can 19. In one embodiment of the present invention, the trap base 4 is removably attached to the can base 21. This configuration allows for the trash can 19 to be retrofitted with the trap container 1. In an alternative embodiment, the trap base 4 is connected to the can base 21. This configuration reflects a trap container 1 that is built into the trash can 19.

In a third embodiment of the present invention, an electrocution trap is used to kill rodents that enter the trap container 1. In this embodiment, the present invention comprises a solar panel and an electrocution plate. The solar panel is used to collect energy produced by the sun and convert said energy into electricity which may be used to electrocute and kill rodents. The solar panel is positioned adjacent to the trash can opposite the can base 21, and is wired to the electrocution pad. The electrocution pad is positioned adjacent to the trap base 4 and is positioned within the trap lateral portion 3. The electrocution pad is used to kill rodents that enter the trap container 1. When a rodent steps on the electrocution pad, an electric current is sent through the rodent from the electrocution pad. A battery may also be incorporated into the circuit to further aid in storing a sufficient amount of electrical energy to kill a rodent.

Although the invention has been explained in relation to its preferred embodiment, it is to be understood that many other possible modifications and variations can be made without departing from the spirit and scope of the invention as hereinafter claimed.

What is claimed is:

1. A trash can trap comprises:
a trap container;
a trap lid;
an at least one trap entrance;
a bait item;
the trap container comprises a rim, a trap lateral portion, and a trap base;
the rim and the trap base being positioned opposite each other about the trap lateral portion;
the rim being perimetrically connected along the trap lateral portion;
the trap base being perimetrically and perpendicularly connected to the trap lateral portion;
the trap lid being hingedly connected to the rim;
the at least one trap entrance traversing through the trap lateral portion;
the bait item being enclosed by the trap container;
each of the at least one trap entrances comprises an entrance tube;
the entrance tube being positioned normal to the trap lateral portion; and
the entrance tube traversing through the trap lateral portion.

2. The trash can trap as claimed in claim 1 comprises:
the trap lid comprises a lid panel, a weight, and a plurality of legs;
the lid panel comprises a proximal surface and a distal surface;
the proximal surface and the distal surface being positioned opposite each other about the lid panel;
the proximal surface being positioned adjacent to the rim;
the weight being adjacently connected to the proximal surface; and
the plurality of legs being adjacently connected to the proximal surface.

3. The trash can trap as claimed in claim 1 comprises:
each of the at least one trap entrances further comprises a one-way door;
the entrance tube comprises a proximal end and a distal end;
the proximal end and the distal end being positioned opposite to each other along the entrance tube;
the one-way door being hingedly connected to the proximal end; and
the proximal end being positioned within the trap lateral portion.

4. The trash can trap as claimed in claim 1 comprises:
a mechanical trap;
the mechanical trap being adjacently connected to the trap base;
the mechanical trap being positioned within the trap lateral portion; and
the bait item being mounted to the mechanical trap.

5. The trash can trap as claimed in claim 4 comprises:
a trap reset pedal;
the trap reset pedal being adjacently connected to the trap lateral portion opposite the mechanical trap; and
the trap reset pedal being mechanically coupled to the mechanical trap.

6. The trash can trap as claimed in claim 1 comprises:
the bait item being poisonous.

7. The trash can trap as claimed in claim 1 comprises:
the trap container being made from a poisonous bait material.

8. The trash can trap as claimed in claim 1 comprises:
a trash can;
the trash can comprises a can lateral portion and a can base;
the can lateral portion being perimetrically and perpendicularly connected to the can base;
the trap lateral portion being positioned within the can lateral portion;
the entrance tube traversing through the can lateral portion; and
the trap base being positioned adjacent to the can base.

9. The trash can trap as claimed in claim 8 comprises:
the trap base being removably attached to the can base.

10. The trash can trap as claimed in claim 8 comprises:
the trap base being connected to the can base.

11. A trash can trap comprises:
a trap container;
a trap lid;
an at least one trap entrance;
a bait item;
a trash can;
the trap container comprises a rim, a trap lateral portion, and a trap base;
the trash can comprises a can lateral portion and a can base;
the rim and the trap base being positioned opposite each other about the trap lateral portion;
the rim being perimetrically connected along the trap lateral portion;
the trap base being perimetrically and perpendicularly connected to the trap lateral portion;
the trap lid being hingedly connected to the rim;
the at least one trap entrance traversing through the trap lateral portion;
the bait item being enclosed by the trap container;
each of the at least one trap entrances comprises an entrance tube;
the entrance tube being positioned normal to the trap lateral portion;
the entrance tube traversing through the trap lateral portion;
the can lateral portion being perimetrically and perpendicularly connected to the can base;
the trap lateral portion being positioned within the can lateral portion;
the entrance tube traversing through the can lateral portion; and
the trap base being positioned adjacent to the can base.

12. The trash can trap as claimed in claim 11 comprises:
the trap lid comprises a lid panel, a weight, and a plurality of legs;
the lid panel comprises a proximal surface and a distal surface;
the proximal surface and the distal surface being positioned opposite each other about the lid panel;
the proximal surface being positioned adjacent to the rim;
the weight being adjacently connected to the proximal surface; and
the plurality of legs being adjacently connected to the proximal surface.

13. The trash can trap as claimed in claim 11 comprises:
each of the at least one trap entrances further comprises a one-way door;
the entrance tube comprises a proximal end and a distal end;
the proximal end and the distal end being positioned opposite to each other along the entrance tube;
the one-way door being hingedly connected to the proximal end; and
the proximal end being positioned within the trap lateral portion.

14. The trash can trap as claimed in claim 11 comprises:
a mechanical trap;
the mechanical trap being adjacently connected to the trap base;
the mechanical trap being positioned within the trap lateral portion; and
the bait item being mounted to the mechanical trap.

15. The trash can trap as claimed in claim 14 comprises:
a trap reset pedal;
the trap reset pedal being adjacently connected to the trap lateral portion opposite the mechanical trap; and
the trap reset pedal being mechanically coupled to the mechanical trap.

16. The trash can trap as claimed in claim 11 comprises:
the bait item being poisonous.

17. The trash can trap as claimed in claim 11 comprises:
the trap container being made from a poisonous bait material.

18. The trash can trap as claimed in claim 17 comprises:
the trap base being removably attached to the can base.

19. The trash can trap as claimed in claim 17 comprises:
the trap base being connected to the can base.
